(19) United States
(12) Patent Application Publication
(10) Pub. No.: US 2026/0085649 A1
(43) Pub. Date: Mar. 26, 2026

(54) FUEL INJECTOR FOR DUAL FUEL APPLICATIONS HAVING NON-RETURN VALVE FOR LEAKAGE CONTROL

(71) Applicant: Caterpillar Inc., Peoria, IL (US)

(72) Inventor: Cory A. Brown, Peoria, IL (US)

(73) Assignee: Caterpillar Inc., Peoria, IL (US)

(21) Appl. No.: 18/897,950

(22) Filed: Sep. 26, 2024

(51) Int. Cl. F02M 43/04

(52) U.S. Cl. CPC F02M 43/04; F02M 2200/46

(57) ABSTRACT

A fuel injector in a dual fuel system includes a first check movable in an injector housing between a closed position blocking a first nozzle outlet, and an open position. The fuel injector further includes a second check movable in the injector housing between a closed position blocking a second nozzle outlet, and an open position. A non-return valve is movable in the injector housing between a closed position blocking a nozzle supply passage, between the first fuel inlet and the first nozzle outlet, and an open position, to limit leakage between two fuel volumes in the fuel injector. The limitation of leakage may be performed during an operating mode of the fuel injector injecting only one fuel, such as a diesel fuel. Related apparatus and methodology is also disclosed.

### TECHNICAL FIELD

The present disclosure relates generally to a fuel injector, and more particularly to a fuel injector in a dual fuel system having a non-return valve movable in the fuel injector to limit leakage between two fuel volumes in the fuel injector.

### BACKGROUND

Dual fuel systems are well known and widely used throughout the world in a variety of internal combustion engine applications. Engineers have developed a number of different strategies over the years enabling an engine to operate on a first fuel, a second fuel, a blend of a first fuel and a second fuel, and in some implementations even more than two fuel types.

Some dual fuel engines operate using a relatively small pilot charge of a compression-ignition liquid fuel to ignite a larger main charge of a gaseous fuel. In recent years, engineering efforts have been increasingly directed at dual liquid fuel strategies such that the engine can operate at least predominantly on one or the other of two liquid fuel types, and sometimes blends, depending upon application and performance requirements. Typically the multiple different fuel types have different properties such as levels of certain emissions when combusted, energy density, or other factors such as availability and cost.

Engines are traditionally configured to operate optimally upon a single fuel type. Different injection pressures and injection amounts, injection timing, and ignition timing may be necessary depending upon fuel type to obtain optimal performance and emissions levels. For instance, certain engine platforms are arranged to operate using liquid methanol some of the time, but at least occasionally operating on diesel in a so-called “diesel-only mode” to obtain optimal performance and in particular respond to transient load changes. Despite much promise in this technical field, there remain a number of challenges including, for example, difficulty in rapidly switching over an engine system from operation on one fuel type to operation on another fuel type. One known dual fuel engine strategy is set forth in United States Patent Application Publication No. 20240044308A1 to Schroeder et al.

### SUMMARY

In one aspect, a fuel injector includes an injector housing forming a first fuel inlet for a first fuel, a second fuel inlet for a second fuel, a first nozzle outlet, a second nozzle outlet, and a nozzle supply passage extending between the first fuel inlet and the first nozzle outlet. The fuel injector further includes a first check movable in the injector housing between a closed position blocking the first nozzle outlet from the nozzle supply passage, and an open position, and a second check movable in the injector housing between a closed position blocking the second nozzle outlet, and an open position. The fuel injector further includes a non-return valve movable in the injector housing between a closed position blocking the nozzle supply passage between the first fuel inlet and the first nozzle outlet, and an open position.

In another aspect, a dual fuel system includes at least one fuel connector forming a first fuel supply conduit for a first fuel and a second fuel supply conduit for a second fuel, and a fuel injector forming a first fuel inlet fluidly connected to the first fuel supply conduit and a second fuel inlet fluidly connected to the second fuel supply conduit. The fuel injector further forms a first nozzle supply passage extending between the first fuel inlet and a first nozzle outlet, a second nozzle supply passage extending between the second fuel inlet and the second nozzle outlet, and the fuel injector defining a leakage path from a fuel volume of the second fuel to a fuel volume of the first fuel, within the fuel injector. The fuel injector further includes a non-return valve movable between an open position, and a closed position blocking the first nozzle supply passage at a location fluidly between the first fuel inlet and the leakage path.

In still another aspect, a method of operating a dual fuel system includes supplying a first fuel at an injection pressure to a fuel injector, and supplying a second fuel at an injection pressure to the fuel injector. The method further includes switching the fuel system from a first mode injecting both the first fuel and the second fuel from the fuel injector into a cylinder in an engine in an engine cycle, to a second mode injecting at least predominantly the second fuel into the cylinder in an engine cycle. The method further includes moving a non-return valve in the fuel injector to a closed position blocking a nozzle supply passage for the first fuel, and limiting leakage of the second fuel within the fuel injector, based on the moving the non-return valve in the fuel injector to a closed position.

### BRIEF DESCRIPTION OF DRAWINGS

FIG. 1 is a diagrammatic view of a dual fuel internal combustion engine, according to one embodiment;

FIG. 2 is a sectioned side diagrammatic view of a dual fuel injector, according to one embodiment;

FIG. 3 is a sectioned side diagrammatic view of a portion of the dual fuel injector of FIG. 2 showing a non-return valve;

FIG. 4 is a side view of a non-return valve, according to one embodiment;

FIG. 5 is a diagrammatic view of a body piece for a dual fuel injector, according to one embodiment;

FIG. 6 is a sectioned diagrammatic view of a portion of a dual fuel injector as in FIG. 2;

FIG. 7 is an end view, in perspective, of a body piece for a dual fuel injector, according to one embodiment; and

FIG. 8 is a side view of a body piece as in FIG. 8.

### DETAILED DESCRIPTION

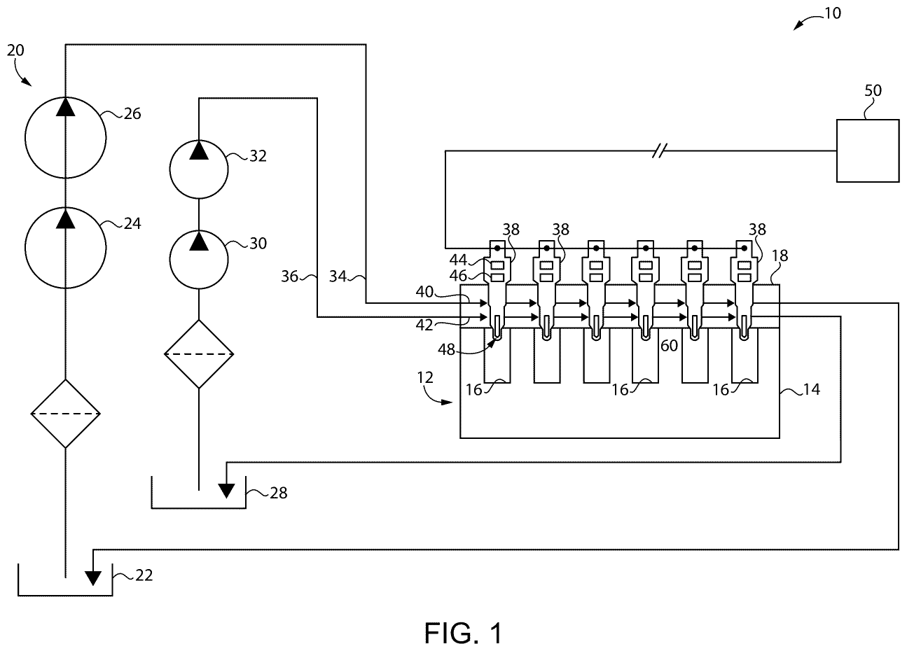

Referring to FIG. 1, there is shown a dual fuel internal combustion engine system 10, according to one embodiment. Engine system 10 includes a dual fuel engine 12 having a cylinder block 14 with a plurality of cylinders 16 formed therein. It will be appreciated that a plurality of pistons can be conventionally positioned in cylinders 16 and each movable between a top-dead-center position and a bottom-dead-center position to rotate a crankshaft in a generally conventional manner. Cylinder 16 can include any number in any suitable arrangement, such as an in-line pattern, a V-pattern, or still another. Engine system 10 can be utilized in a variety of applications including operating a driveline in a land vehicle or a marine vessel, operating a pump, a compressor, or an electrical generator to name a few examples. A cylinder head 18 is attached to cylinder block 14.

Engine system 10 also includes a dual fuel system 20. Fuel system 20 includes a first fuel supply 22 for a first fuel, a low pressure transfer pump 24, and a high pressure pump 26 structured together to feed and pressurize a first fuel stored in first fuel supply 22 to an injection pressure. In a practical implementation high pressure pump 26 may feed the first fuel to a pressurized fluid reservoir or common rail 34. Fuel system 20 also includes a second fuel supply 28, a second fuel transfer pump 30, and a second high pressure pump 32. Second fuel supply stores a second fuel and pumps 30 and 32 are structured together to feed and pressurize the second fuel to a second pressurized fuel reservoir or common rail 36. In an implementation, each of the first fuel and second fuel includes a liquid fuel. The first fuel may be a lower cetane number fuel, for example an alcohol fuel such as methanol, and the second fuel may include a compression-ignition fuel, such as a diesel distillate fuel. The first fuel might alternatively include gasoline, blends of gasoline and an alcohol fuel, or still others. The second fuel may include a higher cetane number fuel such as a diesel fuel as mentioned, or potentially a lower cetane number fuel blended with a cetane enhancer.

It is contemplated that engine 12 and fuel system 20 may be operated in a plurality of different modes including a dual fuel mode where a relatively small pilot charge of diesel is injected into the respective cylinder 16 and compression-ignited to trigger combustion of a larger charge of an alcohol fuel such as methanol. Engine 12 and fuel system 20 may also be operated in a so-called diesel-only or second fuel-only mode, where at least predominantly the second fuel and typically solely the second fuel is injected in an engine cycle. Those skilled in the art will be familiar with various operating strategies, including those described herein as well as others, combining the use of two liquid fuels at a range of substitution ratios and for a variety of different applications. For example, diesel-only mode might be used when a full available power output of engine system 10 is desired and cannot be satisfied in the dual fuel mode, or where diesel-only mode is desirable for transient load changes.

Fuel system 20 further includes at least one fuel connector forming a first fuel supply conduit for the first fuel and a second fuel supply conduit for the second fuel. In the illustrated embodiment fuel system 20 includes a first fuel connector 40 forming the first fuel conduit for the first fuel, and a second fuel connector 42 forming the second fuel conduit for the second fuel, each supported in cylinder head 18. First fuel connector 40 and second fuel connector 42 may each be one of a respective plurality of fuel connectors fluidly connected to first common rail 34 and second common rail 36. Rather than separate fuel connectors for the two fuels, an integrated connector forming separate fuel conduits for the two fuels might alternatively be used. Fuel system 20 further includes a plurality of fuel injectors 38 each supported in cylinder head 18 and extending into a respective one of cylinders 16. Fuel injectors 38 may include direct fuel injectors as illustrated.

Each respective fuel injector 38, hereinafter referred to, at times, in the singular, may be interchangeable for service in fuel system 20 and includes a first injection control valve 44 and a second injection control valve 46. First injection control valve 44 may include an electrically actuated control valve operable to control a timing of a start of injection, an end of injection, and potentially a manner of injection, such as rate shape, of the first fuel. Second injection control valve 46 may be analogously configured to control start of injection, end of injection, potentially manner of injection, of the second fuel. First injection control valve 44 and second injection control valve 46 may be of known design and operation including, for example, solenoid actuated control valves electrically connected to an electronic control unit or ECU 50. Each fuel injector 38 further includes a check assembly 48 operable to selectively inject one or both of the first fuel and the second fuel, as further discussed herein.

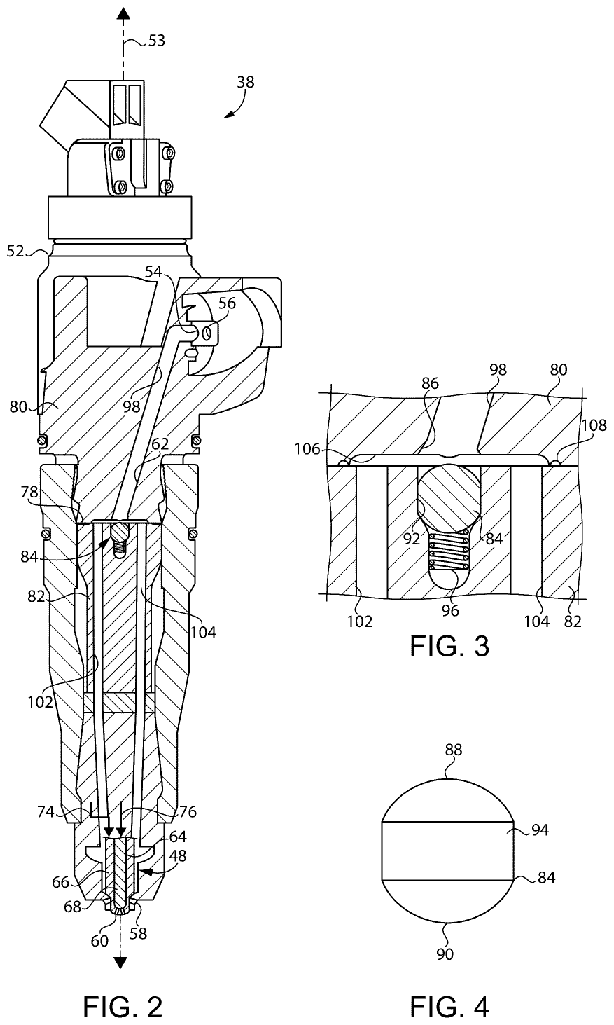

Referring also now to FIG. 2, there is shown fuel injector 38 in further detail. Fuel injector 38 includes an injector housing 52 defining a longitudinal axis 53, and forming a first fuel inlet 54 for the first fuel, a second fuel inlet 56 for the second fuel, a first nozzle outlet 58, and a second nozzle outlet 60. Injector housing 52 further forms a first nozzle supply passage 62 extending between first fuel inlet 54 and first nozzle outlet 58, and a second nozzle supply passage 64 extending between second fuel inlet 56 and second nozzle outlet 60. Each of first nozzle outlet 58 and second nozzle outlet 60 may include a respective set of a plurality of spray orifices. Check assembly 48 may include a first check or outer check 66 movable in injector housing 52 between a closed position blocking first nozzle outlet 58 from first nozzle supply passage 62, and an open position. Check assembly 48 may further include a second check or inner check 68 movable in injector housing 52 between a closed position blocking second nozzle outlet 60 from second nozzle supply passage 64, and an open position.

In the illustrated embodiment, check assembly 48 includes dual concentric checks and dual concentric sets of spray orifices 58 and 60. In other embodiments, two checks having analogous functionality could be positioned side-by-side according to known designs. A pressure control passage 74 formed in injector housing 52 has a fuel pressure that is varied by way of first injection control valve 38 in a known manner to vary a hydraulic pressure applied to a closing hydraulic surface of first check 66 to permit first check 66 to open and close to perform a fuel injection. A second pressure control passage 76 is used generally analogously to vary a hydraulic pressure applied to a closing hydraulic surface of second check 68 by way of second injection control valve 46. The respective closing hydraulic surfaces are not explicitly illustrated in FIG. 2. As suggested above, operating check assembly 48 to selectively inject one or both of the first fuel and the second fuel can be performed by way of known techniques.

Also shown in FIG. 2 are a plurality of body pieces of fuel injector housing 52, including a first body piece 80 that forms first fuel inlet 54 and second fuel inlet 56, and a second body piece 82. A leakage path 78 is defined by injector housing 52 and in the illustrated embodiment includes a leakage path formed at a clamped interface between first body piece 80 and second body piece 82. It should be appreciated that a fuel injector of the type illustrated and described may include numerous body pieces that are fitted together with relatively tight clearances, including match clearances, as well as body pieces that are clamped together at a plurality of different interfaces. A leakage path may include a clearance between two components, including for example between a movable check or other valve component and a stationary piece within which the movable component is guided, a clearance between two movable components, or combinations of these and/or other leakage paths. Leakage path 78 may be understood to extend between any fuel volume of the first fuel and any fuel volume of the second fuel within injector 38. It has been discovered that leakage between parts of injector housing 52, including between first nozzle supply passage 62 and second nozzle supply passage 64, can occur at some or all of these clearances and interfaces, particularly where one fuel is at a higher pressure than the other.

In the dual fuel mode the pressure difference within fuel injector 38 between the first fuel and the second fuel may be relatively minor. Any leakage that does occur can also generally be dealt with by injection of the leaked fuel into the associated cylinder 16. In a diesel-only mode, however, the fuel pressure of the diesel or other second fuel may be substantially higher than fuel pressure of the methanol or other first fuel, resulting in migration of diesel from diesel fuel volumes of fuel injector 38 into methanol fuel volumes of fuel injector 38. Over time, continued leakage of diesel could fill the methanol fuel volumes and even result in diesel flowing out of first fuel inlet 54 intended for the first fuel and mixing of the two fuels outside of fuel injector 38. Such mixing of the fuels can cause problems in fuel supply contamination or result in operational stability difficulties when a switch back to dual fuel mode is attempted. As will be further apparent from the following description, fuel injector 38 is uniquely configured to manage such challenges during service.

Referring also now to FIG. 3, fuel injector 38 may further includes a non-return valve 84 movable in injector housing 52 between a closed position blocking nozzle supply passage 62 between first fuel inlet 54 and first nozzle outlet 58. Blocking of nozzle supply passage 62 may occur at a location that is fluidly between a leakage path in fuel injector 38, such as leakage path 78 or another leakage path, and first fuel inlet 54. As a result, any leakage of the second fuel into fuel volume(s) of, or intended for, the first fuel in fuel injector 38 can be limited to volumes within the fuel injector generally downstream of the leakage path towards the respective nozzle outlets. When diesel-only mode is ended, any accumulated diesel that has migrated to the first fuel “side” of the fuel injector will be injected through first nozzle outlet 58 corresponding otherwise to the first fuel. It can also be noted from FIG. 3 that nozzle supply passage 62 includes an incoming passage 98 extending from first fuel inlet 54, and two outgoing passages 102 and 104 together extending to first nozzle outlet 58. Non-return valve 84 blocks incoming passage 98 from the two outgoing passages 102 and 104 at the closed position.

Focusing also now on FIG. 3, injector housing 52 may form a conical valve seat 86. Non-return valve 84 may include a spherical sealing surface 88 in sealing contact with conical valve seat 86 at the closed position. Injector housing 52 may also form a blind bore 92. Non-return valve 84 may be recessed within blind bore 92 and out of the way of fuel flow of the first fuel at the open position. A biasing spring 96 may be positioned within blind bore 92 and is in contact with non-return valve 84 and biasing non-return valve 84 toward the closed position. Accordingly, an incoming pressure of the first fuel can urge non-return valve 84 out of the way to permit unobstructed incoming flow of the first fuel. When the supply pressure of the first fuel is reduced, such as in diesel-only mode, biasing spring 96 can act to urge non-return valve 84 against conical valve seat 86. Non-return valve 84 may further include a cylindrical outer guide surface 94 guiding movement of non-return valve 84 between the open position and the closed position within blind bore 92. A second spherical sealing surface 90 may be positioned upon non-return valve 84 opposite spherical sealing surface 84.

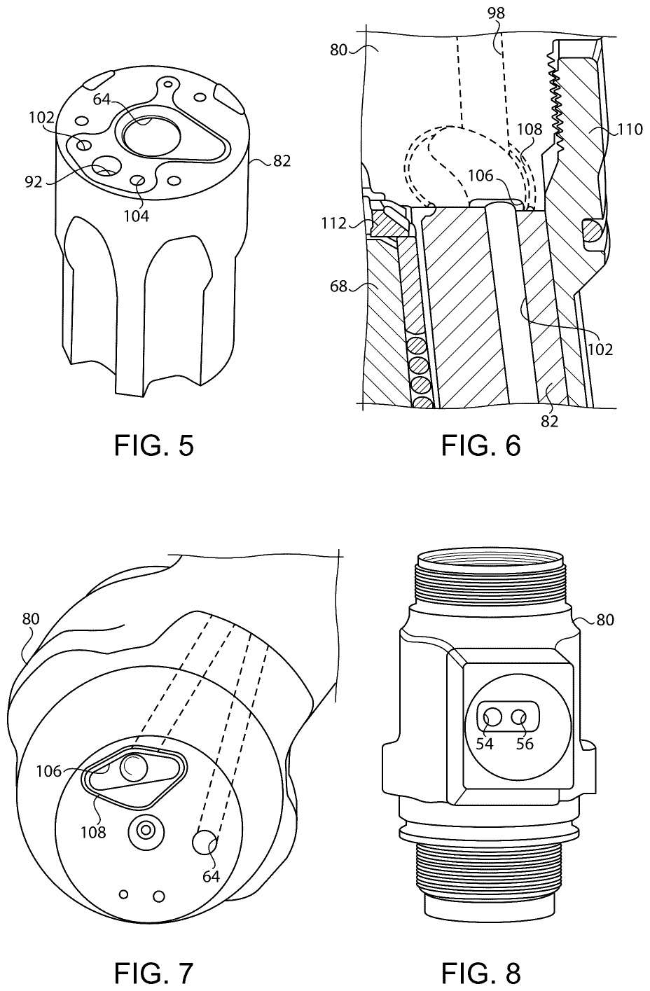

Referring also now to FIGS. 5-8, there are shown additional features of fuel injector 38, including second nozzle supply passage 64 extending through body piece 82 in FIG. 5. Injector housing 52 may further form a bathtub connection 106, as can be seen in FIGS. 3 and 6 in particular, that fluidly connects incoming passage 98 to outgoing passages 102 and 104. A bathtub connection forms a shallow, broad, and connecting volume having curvilinear sides or ends, permitting flow of the first fuel to advance with minimal pressure drop or flow disturbances into outgoing passages 102 and 104. A bathtub connection may also be relatively stress resistant and less prone to cracking than other fluid junction designs.

In the illustrated embodiment, first body piece 80 forms conical seat 86, incoming passage 98 and also bathtub connection 106. In other embodiments a bathtub connection might be formed in whole or in part in second body piece 82. Second body piece 82 also forms the two outgoing passages 102 and 104 and second nozzle supply passage 64. Focusing on FIG. 6, injector housing 38 may further form a diesel or second fuel moat 108 extending around bathtub connection 106. Moat 108 may include a groove or the like formed in first body piece 80, and will contain diesel to assist in providing a fluid seal between volumes of the first fuel and the second fuel within fuel injector 38. As discussed above, the diesel pressure will typically be higher than the methanol pressure, thus ensuring moat 108 is charged with pressurized diesel that can assist in preventing leakage. Moat 108 could potentially be located at other locations. FIG. 6 also illustrates a casing 110 of injector housing 52, and an orifice plate 112 or the like associated with check 68.

### INDUSTRIAL APPLICABILITY

Referring to the drawings generally, operating dual fuel system 20 can include supplying the first fuel at an injection pressure to fuel injectors 38, and supplying the second fuel at an injection pressure to fuel injectors 38. In circumstances discussed above, and by way of example, fuel system 20 may be operated in a first mode injecting both the first fuel and the second fuel from fuel injectors 38 into cylinders 16 in engine 12 in an engine cycle. Fuel system 20 may be switched to a second mode injecting at least predominantly the second fuel, and typically solely the second fuel.

With the switching of fuel system 20 to the second mode, a supply pressure of the first fuel may be reduced such as by adjusting or turning off high pressure pump 26. The pressure in incoming passage 98 can then be expected to drop, permitting non-return valve 84 to move towards a closed position limiting any leakage of the second fuel into nozzle supply passage 62, in particular into incoming passage 98. When fuel system 20 is to be switched back to a dual fuel mode, pressure of the first fuel can be increased back up to a suitable injection pressure, and non-return valve 84 will be moved back towards its open position, permitting the injection and combustion of any leaked diesel that has accumulated in the first fuel volumes of fuel injector 38.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more. ” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A fuel injector comprising:
an injector housing forming a first fuel inlet for a first fuel, a second fuel inlet for a second fuel, a first nozzle outlet, a second nozzle outlet, and a nozzle supply passage extending between the first fuel inlet and the first nozzle outlet;
a first check movable in the injector housing between a closed position blocking the first nozzle outlet from the nozzle supply passage, and an open position;
a second check movable in the injector housing between a closed position blocking the second nozzle outlet, and an open position; and
a non-return valve movable in the injector housing between a closed position blocking the nozzle supply passage between the first fuel inlet and the first nozzle outlet, and an open position.

2. The fuel injector of claim 1 wherein the injector housing forms a conical valve seat, and the non-return valve includes a spherical sealing surface in contact with the conical valve seat at the closed position.

3. The fuel injector of claim 2 wherein the injector housing forms a blind bore, and the non-return valve is within the blind bore at the open position.

4. The fuel injector of claim 3 wherein the non-return valve includes a cylindrical outer guide surface.

5. The fuel injector of claim 3 further comprising a biasing spring within the blind bore and in contact with the non-return valve and biasing the non-return valve toward the closed position.

6. The fuel injector of claim 2 wherein the nozzle supply passage includes an incoming passage extending from the first fuel inlet, and two outgoing passages extending to the first nozzle outlet, and the non-return valve blocks the incoming passage from the two outgoing passages at the closed position.

7. The fuel injector of claim 6 wherein the injector housing further forms a bathtub connection between the incoming passage and the two outgoing passages.

8. The fuel injector of claim 7 wherein the injector housing further includes a first body piece forming the conical seat and the incoming passage, and a second body piece forming the two outgoing passages and a second nozzle supply passage extending between the second fuel inlet and the second nozzle outlet.

9. The fuel injector of claim 8 wherein the injector housing further forms a moat extending around the bathtub connection.

10. The fuel injector of claim 8 wherein each of the bathtub connection and the moat are formed in the first body piece.

11. A dual fuel system comprising:
at least one fuel connector forming a first fuel supply conduit for a first fuel and a second fuel supply conduit for a second fuel;
a fuel injector forming a first fuel inlet fluidly connected to the first fuel supply conduit and a second fuel inlet fluidly connected to the second fuel supply conduit;
the fuel injector further forming a first nozzle supply passage extending between the first fuel inlet and a first nozzle outlet, a second nozzle supply passage extending between the second fuel inlet and a second nozzle outlet, and defining a leakage path from a fuel volume of the second fuel to a fuel volume of the first fuel, within the fuel injector; and
the fuel injector further including a non-return valve movable between an open position, and a closed position blocking the first nozzle supply passage at a location fluidly between the first fuel inlet and the leakage path.

12. The fuel system of claim 11 wherein the leakage path is defined through a clearance in the fuel injector.

13. The fuel system of claim 11 wherein the first nozzle supply passage includes an incoming passage extending from the first fuel inlet, and two outgoing passages extending to the first nozzle outlet, and the non-return valve blocks the incoming passage from the two outgoing passages at the closed position.

14. The fuel system of claim 13 wherein the fuel injector further forms a bathtub connection between the incoming passage and the two outgoing passages.

15. The fuel system of claim 14 wherein the fuel injector further forms a moat extending around the bathtub connection.

16. The fuel system of claim 11 wherein the non-return valve includes a spherical sealing surface, and a cylindrical outer guide surface, and further comprising a biasing spring biasing the non-return valve toward the closed position.

17. The fuel system of claim 11 wherein the fuel injector forms a blind bore, and the non-return valve is within the blind bore at the open position.

18. A method of operating a dual fuel system comprising:
supplying a first fuel at an injection pressure to a fuel injector;
supplying a second fuel at an injection pressure to the fuel injector;
switching the fuel system from a first mode injecting both the first fuel and the second fuel from the fuel injector into a cylinder in an engine in an engine cycle, to a second mode injecting at least predominantly the second fuel into the cylinder in an engine cycle;
moving a non-return valve in the fuel injector to a closed position blocking a nozzle supply passage for the first fuel; and
limiting leakage of the second fuel within the fuel injector, based on the moving the non-return valve in the fuel injector to a closed position.

19. The method of claim 18 wherein the moving the non-return valve includes moving the non-return valve via a biasing force of a biasing spring from an open position within a blind bore in the fuel injector, to a closed position where a spherical sealing surface of the non-return valve contacts a valve seat in the fuel injector to block an incoming passage of the nozzle supply passage from two outgoing passages of the nozzle supply passage.

20. The method of claim 18 wherein the first fuel includes an alcohol fuel, and the second fuel includes a diesel fuel.
